(19) United States
(12) Patent Application Publication
(10) Pub. No.: US 2019/0278274 A1
(43) Pub. Date: Sep. 12, 2019

(54) AUTONOMOUS MOBILE OBJECT, MEDICINE DELIVERY SYSTEM, MEDICINE DELIVERY METHOD USING AUTONOMOUS MOBILE OBJECT, AND MOBILE OBJECT

(71) Applicant: Toyota Jidosha Kabushiki Kaisha, Toyota-shi Aichi-ken (JP)

(72) Inventors: Hiroshi Igata, Yokohama-shi Kanagawa-ken (JP); Yuchi Yamanouchi, Toyota-shi Aichi-ken (JP); Atsushi Sajiki, Okazaki-shi Aichi-ken (JP); Hidenari Soya, Toyota-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/291,614

(22) Filed: Mar. 4, 2019

(30) Foreign Application Priority Data
Mar. 6, 2018 (JP) 2018-039599

(51) Int. Cl. G05D 1/02; B60P 3/00; G06Q 30/06; G06Q 10/08

(52) U.S. Cl. CPC G05D 1/0212; B60P 3/007; G05D 2201/0213; G06Q 30/0607; G06Q 10/0832; G05D 1/0276

(57) ABSTRACT

An autonomous mobile object configured to travel with a medicine loaded therein includes a movement controller configured to control the autonomous mobile object such that the autonomous mobile object autonomously travels to a designated place according to a request of a customer, an information provision unit configured to provide information on the medicine to the customer; and a product provision unit configured to provide the medicine to the customer when a predetermined condition is met.

### CROSS-REFERENCE TO RELATED APPLICATION

This application claims priority to Japanese Patent Application No. 2018-039599 filed on Mar. 6, 2018, incorporated herein by reference in its entirety.

### BACKGROUND

### 1. Technical Field

The present disclosure relates to an autonomous mobile object configured to deliver medicines, a medicine delivery system and a medicine delivery method using the autonomous mobile object, and a mobile object.

### 2. Description of Related Art

In recent years, as e-commerce is becoming widespread, the convenience of shopping at home rather than visiting stores in person is improving. However, it has been difficult to sell medicines online since, by regulation, certain medicines are required to be sold face-to-face in order to determine whether it is appropriate to sell a medicine to a customer. As a disclosure to solve the problem, for example, Japanese Unexamined Patent Application Publication No. 2002-024390 (JP 2002-024390 A) discloses an online shopping system in which a qualified person consults with a customer via a network to determine whether it is appropriate to sell the medicine to the customer.

### SUMMARY

The system disclosed in JP 2002-024390 A enables online sales of medicines. However, in online sales, it generally takes some time for customers to receive the products they order. Since people tend to buy medicines after they are sick, there has been a demand for a system that enables customers to order medicines at home and provides for a prompt delivery of the ordered medicines.

The present disclosure provides an autonomous mobile object configured to promptly deliver medicines subject to sales regulations, a system and a method for promptly delivering medicines subject to sales regulations, and a mobile object.

An autonomous mobile object according to a first aspect of the present disclosure is configured to travel with a medicine loaded therein. The autonomous mobile object includes a movement controller configured to control the autonomous mobile object such that the autonomous mobile object autonomously travels to a designated place according to a request of a customer, an information provision unit configured to provide information on the medicine to the customer, and a product provision unit configured to provide the medicine to the customer when a predetermined condition is met.

Furthermore, the predetermined condition may vary depending on an attribute of the medicine.

The autonomous mobile object autonomously travels on roads, and is configured to travel with a medicine loaded therein. The autonomous mobile object has an objective of travelling primarily on roads, and may be an autonomous driving vehicle.

Information is provided to the customer to whom the medicine is provided. In countries such as Japan, it is obligatory to provide information to customers on medicines requiring safety attention regarding, for example, side effects and interactions. The information may be provided, for example, via document (written or electronic) or via telephone (voice call, video call, or the like).

The product provision unit provides the medicine to the customer when a predetermined condition is met and may be configured to provide a plurality of medicines. The predetermined condition varies depending on the attribute of the medicines. For example, when medicines are classified into a plurality of categories according to the degree of required attention, the condition to be met is set for each category. The condition typically includes, but is not limited to, providing the customer with a sufficient description on the medicine, and verifying whether it is safe to sell the medicine to the customer. With the above configuration, it is possible to determine whether medicines can be provided to the customer based on criteria according to the attribute of each medicine. In other words, it is possible for various medicines subject to various sales regulations to be ordered at home and delivered immediately.

In addition, the attribute of the medicine may be based on the level of sales regulations to which the medicine is subject.

With the above configuration, an appropriate condition can be selected from a plurality of conditions based on the level of sales regulations to which the medicine is subject.

Furthermore, the predetermined condition may include at least one of a condition that information on the medicine has been provided and a condition that the identity of the customer has been verified.

With the above configuration, it is possible to provide medicines which require appropriate information on side effects or interactions, or medicines that can only be provided to specifically designated customers.

In addition, the information on the medicine may be provided via a telephone call between a provider of the information and the customer.

The provider of the information may be a person qualified for selling or dispensing the medicine.

By causing a voice call to be made between the qualified person, such as a sales person of the medicine or a pharmacist, and the customer, it is possible to provide appropriate information at the place where the autonomous mobile object arrives.

Furthermore, the product provision unit may provide, to the customer, the medicine selected by the qualified person from a plurality of medicines loaded in the autonomous mobile object.

With the above configuration, it is possible to provide an appropriate medicine according to the customer's medical condition or the like from the plurality of medicines.

In addition, the product provision unit may include a return unit into which a medicine kept by the customer is returned, and the predetermined condition may include a condition that the medicine kept by the customer has been returned into the return unit.

The medicine kept by the customer may include, for example, a medicine that is approaching (or have already passed) its expiration date. As such, for example, the medicine kept by the customer can be periodically replaced.

Moreover, a medicine delivery system according to a second aspect of the present disclosure includes an autonomous mobile object configured to be loaded with a medicine and autonomously travel based on an operation command, and a server apparatus configured to generate the operation command. The autonomous mobile object includes a movement controller configured to control the autonomous mobile object such that the autonomous mobile object autonomously travels to a designated place based on the operation command, an information provision unit configured to provide information on the medicine to a customer, and a product provision unit configured to provide the medicine to the customer when a predetermined condition is met. The server apparatus is configured to generate the operation command based on a request of the customer, and transmit the generated operation command to the autonomous mobile object.

As such, the second aspect of the present disclosure may be specified as a system including a server apparatus that issues an operation command to the autonomous mobile object based on the request of the customer.

Moreover, the server apparatus may include a collection unit configured to collect an inventory status of a medicine kept by the customer, and the predetermined condition may include a condition that the medicine needs to be replaced or replenished according to the inventory status.

For example, when there is a storage device or the like in which the customer stores medicines, the server apparatus may acquire the inventory status of the medicine from the storage device. Further, the server apparatus may acquire the inventory status of the medicine based on the customer's input. The inventory status may be information indicating the expiration date or the like, in addition to the remaining quantity of the medicine. When the inventory status indicates that the medicine is running low or the expiration date is approaching, the server apparatus generates an operation command to the autonomous mobile object based on the corresponding inventory status. As such, the customer can keep a sufficient quantity of medicines.

A medicine delivery method using an autonomous mobile object loaded with a medicine, according to a third aspect of the present disclosure, includes a step of autonomously travelling to a designated place according to a request of a customer, a step of providing information on the medicine to the customer, and a step of providing the medicine to the customer when a predetermined condition is met.

A mobile object according to a fourth aspect of the present disclosure includes a loading unit configured to be loaded with a medicine, an information provision unit configured to provide information on the medicine to a customer, and a product provision unit configured to provide the medicine to the customer when a predetermined condition is met.

Furthermore, the aspect of the present disclosure may be specified as an autonomous mobile object or a medicine delivery system including at least part of the above-described configuration. The aspect of the present disclosure may also be specified as a method performed by the autonomous mobile object or the medicine delivery system. The above-described processing or configuration can be freely combined and implemented within a range in which no technical contradiction arises.

With each aspect of the present disclosure, medicines subject to sales regulations can be delivered promptly.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a conceptual diagram of a delivery system according to a first embodiment;

FIG. 2 is a block diagram schematically illustrating an example of each constituent element of the delivery system;

FIG. 3 illustrates the exterior of a storage apparatus;

FIG. 4 illustrates the exterior of an autonomous vehicle;

FIG. 5 illustrates the flow of data transmitted and received between constituent elements of the system;

FIG. 6 is a flowchart showing processes performed by the autonomous vehicle;

FIG. 7A illustrates conditions for providing medicines according to a first embodiment;

FIG. 7B illustrates conditions for providing medicines according to a second embodiment;

FIG. 8 is a flowchart showing processes performed by the autonomous vehicle according to the second embodiment;

FIG. 9A is a block diagram schematically illustrating an example of each constituent element of a medicine management device according to the second embodiment; and

FIG. 9B illustrates the exterior of the medicine management device according to the second embodiment.

### DETAILED DESCRIPTION

### First Embodiment

System Overview

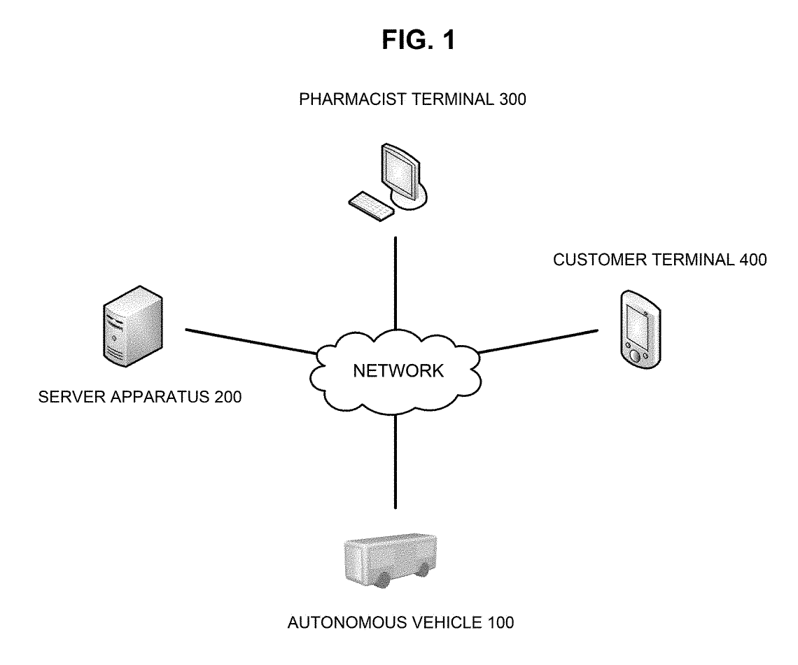

An overview of a delivery system according to a first embodiment will be described with reference to FIG. 1. The delivery system according to the present embodiment includes a plurality of autonomous vehicles 100 that autonomously travel based on a given command, a server apparatus 200 that issues the given command, a pharmacist terminal 300, and a customer terminal 400. The autonomous vehicles 100 are autonomous driving vehicles that provide a medicine delivery service, and the server apparatus 200 manages the plurality of autonomous vehicles 100. The pharmacist terminal 300 is used by a pharmacist, and the customer terminal 400 is used by the customer who requests delivery of a medicine. The autonomous vehicles 100, the server apparatus 200, the pharmacist terminal 300, and the customer terminal 400 are connected to one another via a network. In addition, although FIG. 1 illustrates one autonomous vehicle 100 as an example, the delivery system may include two or more autonomous vehicles 100. The same applies to the pharmacist terminal 300 and the customer terminal 400.

The autonomous vehicle 100 is an autonomous driving vehicle capable of travelling with medicines loaded therein. The autonomous vehicle 100 is also referred to as an Electric Vehicle (EV) palette. Furthermore, the autonomous vehicle 100 does not necessarily need to be an unmanned vehicle. For example, a sales person, a customer service agent, or a security guard may board the autonomous vehicle 100. In addition, the autonomous vehicle 100 does not necessarily need to be a vehicle capable of completely autonomous travelling. For example, the autonomous vehicle 100 may be driven or assisted in driving by a person, depending on the situation. The autonomous vehicle 100 can travel with a plurality of medicines loaded therein.

In the present embodiment, the server apparatus 200 receives a request to deliver a medicine from the customer terminal 400 managed by the customer. Upon receiving the request, the server apparatus 200 generates an operation command to cause the autonomous vehicle 100 to head towards the customer's location, and transmits the generated operation command to the autonomous vehicle 100. In response to this, the autonomous vehicle 100 autonomously travels to the destination given from the server apparatus 200. When the autonomous vehicle 100 arrives at the customer's location, the pharmacist remotely speaks with the customer via the pharmacist terminal 300 (for example, via voice call), and provides information on the medicine to the customer. When the pharmacist remotely performs operation for providing the medicine based on the results of the information provision, the medicine is provided to the customer from an apparatus (to be described below) loaded in the autonomous vehicle 100. With the above-described configuration, it is possible to make an unmanned delivery of medicines that require guidance for sale from a pharmacist or the like.

System Configuration

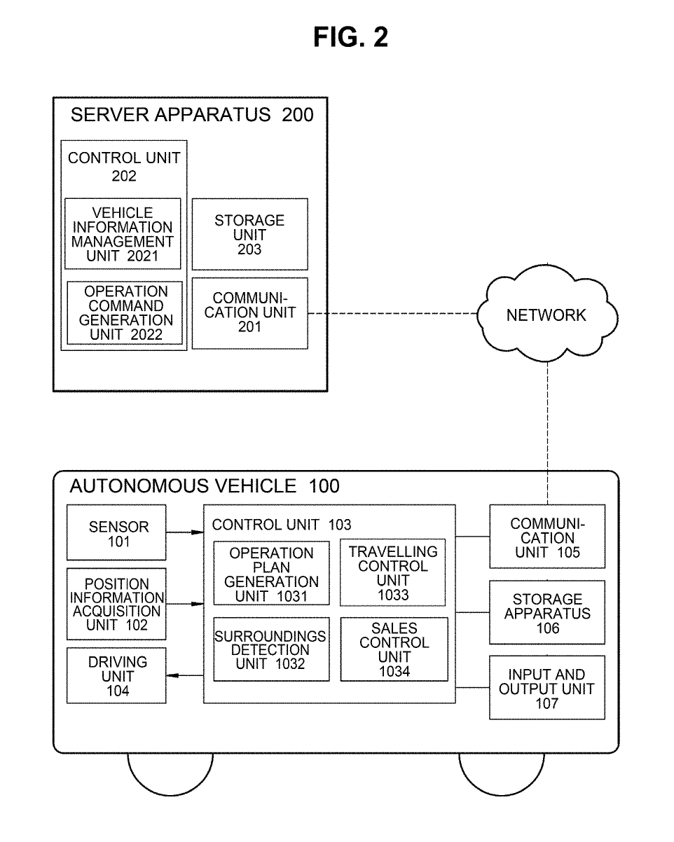

Constituent elements of the system will be described in detail. FIG. 2 is a block diagram schematically illustrating one example of the autonomous vehicle 100 and the server apparatus 200, illustrated in FIG. 1. Further, although FIG. 2 illustrates one autonomous vehicle 100, the delivery system may include a plurality of autonomous vehicles 100.

The autonomous vehicle 100 travels according to an operation command acquired from the server apparatus 200. In particular, the autonomous vehicle 100 specifies a travelling route based on the operation command acquired through wireless communication, and travels on a road in an appropriate manner while sensing the surroundings of the vehicle.

The autonomous vehicle 100 includes a sensor 101, a position information acquisition unit 102, a control unit 103, a driving unit 104, a communication unit 105, and a storage apparatus 106. The autonomous vehicle 100 is operated by power supplied from a battery (not shown).

The sensor 101 senses the surroundings of the vehicle and typically includes a stereo camera, a laser scanner, a Light Detection And Ranging (LIDAR), a radar, or the like. The information acquired by the sensor 101 is transmitted to the control unit 103. The sensor 101 includes a sensor that supports autonomous travelling of the subject vehicle. The sensor 101 may include a camera mounted on the vehicle body of the autonomous vehicle 100. For example, the sensor 101 may include an imaging device using an image sensor, such as a Charge-Coupled Device (CCD), a Metal-Oxide-Semiconductor (MOS), or a Complementary Metal-Oxide-Semiconductor (CMOS). A plurality of cameras may be installed at a plurality of places on the vehicle body. For example, cameras may be respectively installed at the front, rear, right, and left sides of the vehicle body.

The position information acquisition unit 102 acquires the current position of the vehicle, and typically includes a Global Positioning System (GPS) receiver, or the like. The information acquired by the position information acquisition unit 102 is transmitted to the control unit 103.

The control unit 103 is a computer (an example of an operation controller in the present disclosure) that controls the autonomous vehicle 100 based on the information acquired from the sensor 101. The control unit 103 is, for example, a microcomputer.

The control unit 103 includes, as functional modules, an operation plan generation unit 1031, a surroundings detection unit 1032, a travelling control unit 1033, and a sales control unit 1034. Each functional module may be implemented by executing a program stored in a storage medium, such as a Read Only Memory (ROM), using a Central Processing Unit (CPU) (neither shown).

The operation plan generation unit 1031 acquires an operation command from the server apparatus 200 and generates an operation plan for the subject vehicle. In the present embodiment, the operation plan is data that defines a route along which the autonomous vehicle 100 travels, and a process to be performed by the autonomous vehicle 100 in a part of or the whole of the route. Examples of the data included in the operation plan will be described below.

(1) Data Representing Route Along which Subject Vehicle Travels as Set of Road Links

A route along which the subject vehicle travels may be automatically generated based on a given starting point and a given destination, for example, by referring to map data stored in the storage medium (not shown). In addition, the route along which the subject vehicle travels may be generated using an external service.

(2) Data Representing Process to be Performed by Subject Vehicle at Designated Point on Route

Processes which the subject vehicle performs on the route include, but are not limited to, for example, “Call the customer”, “Have the customer and the pharmacist communicate”, “Process a payment for the medicine”, and “Provide the medicine based on the pharmacist's instruction”. The operation plan generated by the operation plan generation unit 1031 is transmitted to the travelling control unit 1033 (to be described below).

The surroundings detection unit 1032 detects the surroundings of the vehicle based on the data acquired by the sensor 101. Objects to be detected include, but are not limited to, for example, the number and positions of lanes, the number and positions of other vehicles around the subject vehicle, the number and positions of obstacles around the subject vehicle (for example, pedestrians, bicycles, structures, and buildings), road structures, and road signs. Any object necessary to be detected for autonomous travelling may be detected. Furthermore, the surroundings detection unit 1032 may track a detected object. For example, the surroundings detection unit 1032 may acquire a relative speed of an object from a difference between the coordinates of the object detected one step previously, and the current coordinates of the object. The data on surroundings detected by the surroundings detection unit 1032 (hereinafter, the surroundings data) is transmitted to the travelling control unit 1033 (to be described below).

The travelling control unit 1033 (an example of a movement controller in the present disclosure) controls travelling of the subject vehicle based on the operation plan generated by the operation plan generation unit 1031, the surroundings data generated by the surroundings detection unit 1032, and subject vehicle position information acquired by the position information acquisition unit 102. For example, the travelling control unit 1033 causes the subject vehicle to travel along a designated route such that obstacles do not enter a designated safety area around the subject vehicle. As a method for autonomous travelling of the vehicle, a well-known method may be employed.

A sales control unit 1034 (an example of an information provision unit and a product provision unit in the present disclosure) controls the sale of medicines at a destination. The controls on the sale of medicines include, but are not limited to, for example, the controls to call the customer, to have the customer and the pharmacist communicate, and to provide medicines based on the pharmacist's instruction. The controls on the sale of medicines are performed based on the operation plan generated by the operation plan generation unit 1031, and if necessary, based on the surroundings data generated by the surroundings detection unit 1032, the subject vehicle position information acquired by the position information acquisition unit 102, or the like.

The driving unit 104 causes the autonomous vehicle 100 to travel based on the commands generated by the travelling control unit 1033. The driving unit 104 includes, for example, a motor, an inverter, a brake, a steering mechanism, and a secondary battery that are used to drive the autonomous vehicle 100. The communication unit 105 is a communication interface that connects the autonomous vehicle 100 to a network. In the present embodiment, the communication unit 105 may communicate with other apparatuses (the server apparatus 200, the pharmacist terminal 300, and the customer terminal 400) through the network via mobile communication services, such as 3rd generation (3G) or Long Term Evolution (LTE). Furthermore, the communication unit 105 may further include a communication tool to communicate with another autonomous vehicle 100.

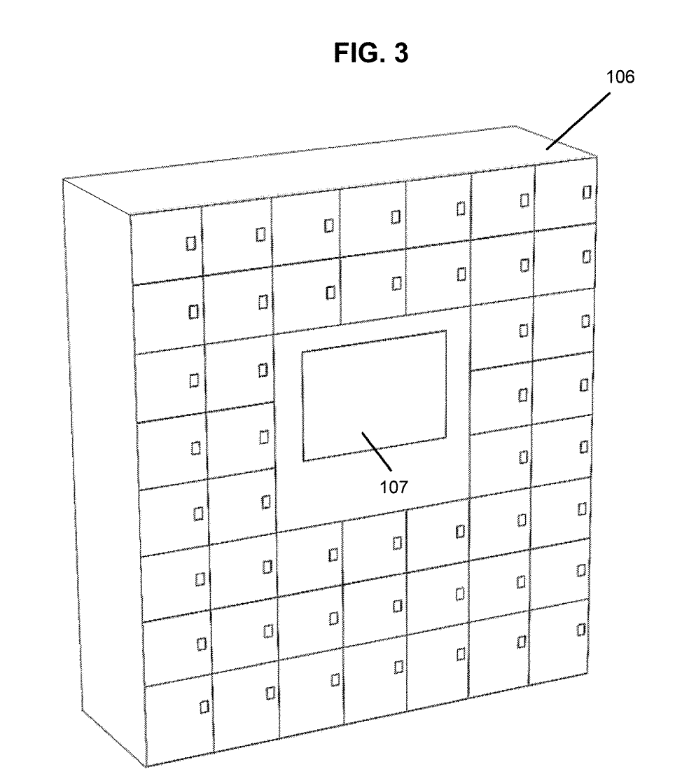

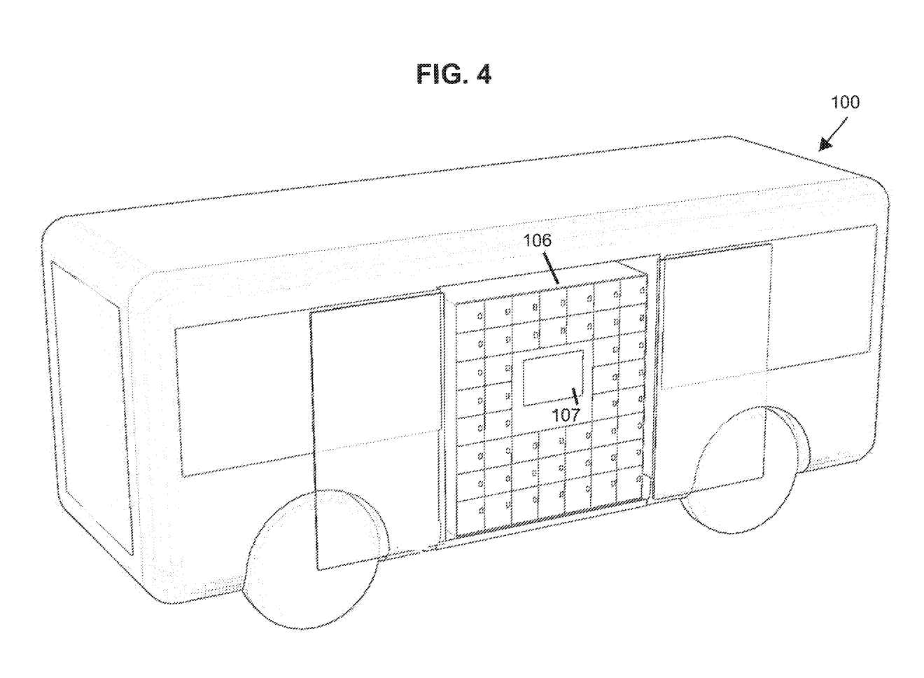

The storage apparatus 106 has a plurality of compartments each of which can store a medicine therein. FIG. 3 shows the exterior of the storage apparatus 106. As illustrated in FIG. 3, the storage apparatus 106 is provided with a plurality of doors, and each of the compartments of the storage apparatus 106 is configured to be accessible via a corresponding one of the doors. Each door is configured to be lockable, and is unlocked when a predetermined condition is met. Detailed steps for unlocking the doors will be described below. The above-described constituent elements are controlled by the sales control unit 1034. In addition, FIG. 3 illustrates an example of a configuration in which the storage apparatus 106 and an input and output unit 107 (to be described below) are integrated into one. The storage apparatus 106 can be loaded in the autonomous vehicle 100. FIG. 4 illustrates an example of the autonomous vehicle 100 in which the storage apparatus 106 accessible from the outside is loaded. The door of the autonomous vehicle 100 is a sliding door.

The input and output unit 107 receives an input made by the customer and provides information to the customer. In particular, the input and output unit 107 includes a touch panel, a liquid crystal display, a keyboard, a mouse, a microphone, a speaker, a camera capturing an image of the customer or the like, and a controller that controls these devices. Instead of the touch panel and the liquid crystal display, a touch panel display may be used.

Next, the server apparatus 200 will be described. The server apparatus 200 manages the position and state of the plurality of autonomous vehicles 100, and transmits an operation command. The server apparatus 200, for example, upon receiving a request from the customer to deliver a medicine to a designated place, acquires a destination, and then transmits an operation command to an autonomous vehicle 100 available for delivery.

The server apparatus 200 includes a communication unit 201, a control unit 202, and a storage unit 203. The communication unit 201, similar to the communication unit 105, is a communication interface to communicate with the autonomous vehicle 100 via the network.

The control unit 202 controls the server apparatus 200. The control unit 202 is, for example, a CPU. The control unit 202 includes, as functional modules, a vehicle information management unit 2021 and an operation command generation unit 2022. Each functional module may be implemented by executing a program stored in the storage medium, such as a ROM, using a CPU (neither shown).

The vehicle information management unit 2021 manages the plurality of autonomous vehicles 100. Specifically, the vehicle information management unit 2021 acquires data on the autonomous vehicles 100 at predetermined intervals, from the plurality of autonomous vehicles 100, and stores the acquired data in the storage unit 203 (to be described below). In the present embodiment, the vehicle information management unit 2021 acquires position information and vehicle information, as the data on the autonomous vehicle 100. The vehicle information may include, but is not limited to, for example, an identifier, a usage and type of the vehicle, information on a holding area (a sales base), a door type, a vehicle body size, a trunk size, a loading capacity, a travelable distance when fully charged, a travelable distance at a current time point, and a current status (whether the autonomous vehicle 100 is in the middle of performing a task, or the like).

When the server apparatus 200 receives an operation request for an autonomous vehicle 100, the operation command generation unit 2022 determines which autonomous vehicle 100 to send, and generates an operation command responding to the operation request. The operation request is, for example, a request to deliver a medicine to a designated place. The request may include an identifier of the customer who requests the delivery, the name, type and number of the medicine ordered, and the like, in addition to the destination.

An operation request may be issued by the end customer to whom the medicine is delivered, a system manager, or a system operator. In the following description, a subject who issues a request will be collectively referred to as a customer.

The autonomous vehicle 100 to which the operation command is transmitted is determined, for example, according to the vehicle position information and the vehicle information (information on whether the vehicle is available for delivering the medicine) of each vehicle, which are acquired by the vehicle information management unit 2021. Furthermore, the server apparatus 200, upon receiving the operation request, may transmit the operation command to cause the autonomous vehicle 100 to immediately move toward the destination, but may also transmit the operation command to cause the autonomous vehicle 100 to stand by for a predetermined period of time in order to receive a plurality of operation commands.

The storage unit 203 stores information, and includes a storage medium, such as a RAM, a magnetic disk, or a flash memory.

Next, the pharmacist terminal 300 will be described. The pharmacist terminal 300 is used by the pharmacist who remotely communicates with the customer. The pharmacist terminal 300 may be, for example, a personal computer, or a small computer such as a smart phone, a mobile phone, a tablet terminal, a personal information terminal or a wearable computer (a smart watch or the like). The pharmacist terminal 300 is connected to the autonomous vehicle 100 via the network. The pharmacist can use the pharmacist terminal 300 to communicate with the customer through the input and output unit 107.

Next, the customer terminal 400 will be described. The customer terminal 400 is used by the customer who will receive the medicine to be delivered. The customer terminal 400 may be, for example, a personal computer, or a small computer such as a smart phone, a mobile phone, a tablet terminal, a personal information terminal or a wearable computer (a smart watch or the like). The customer terminal 400 is connected to the server apparatus 200 via the network, and can transmit an operation request to the corresponding server apparatus 200. Further, in the same manner, the customer terminal 400 is connected to the autonomous vehicle 100 via the network, and can receive a notification from the corresponding autonomous vehicle 100.

System Operation

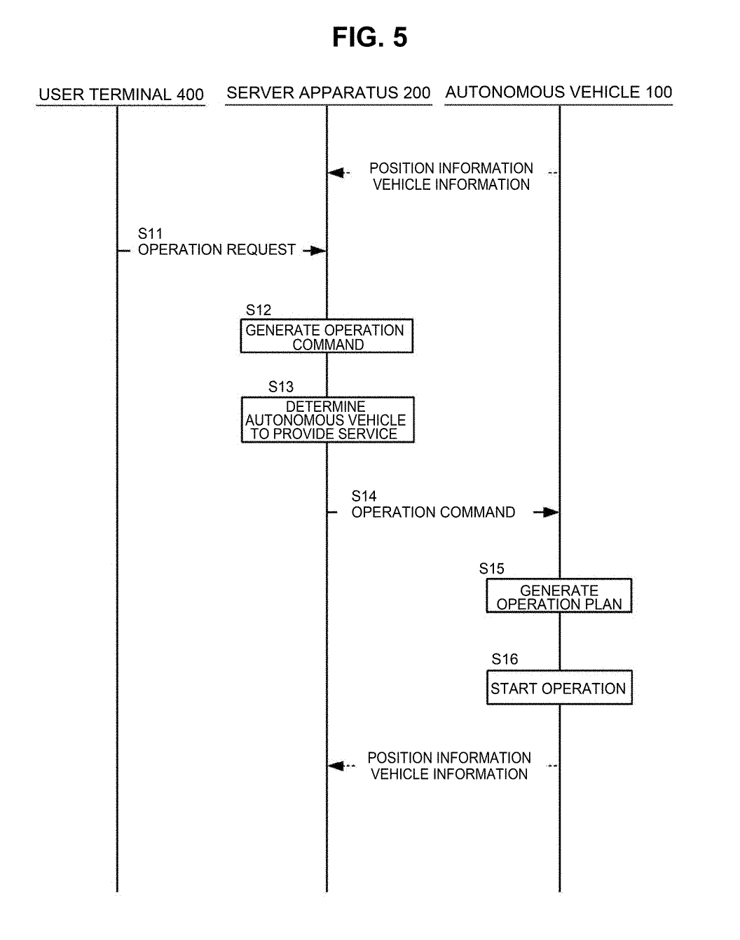

Next, the processes performed by the above-described respective constituent elements will be described. FIG. 5 illustrates a dataflow from generation of an operation command by the server apparatus 200 based on an operation request acquired from a customer to the start of an operation by the autonomous vehicle 100.

The autonomous vehicle 100 periodically notifies the server apparatus 200 of position information. The position information may be, for example, when a road network is defined by nodes and links, information specifying nodes and links. Furthermore, the position information may be coordinates, such as latitude or longitude. The vehicle information management unit 2021 causes the storage unit 203 to store the notified position information in association with the autonomous vehicle 100. Whenever the autonomous vehicle 100 moves, the position information is updated.

Further, the autonomous vehicle 100 periodically notifies the server apparatus 200 of vehicle information. In the present embodiment, the autonomous vehicle 100 transmits the following information as the vehicle information. Moreover, among the information listed below, information unique to the autonomous vehicle 100 does not need to be repeatedly transmitted.
information on the medicine currently loaded (name, type, number, or the like);
a current State Of Charge (SOC) of a battery;
a travelable distance; and
information on an operation route (when the vehicle is presently in operation).

In addition, when the autonomous vehicle 100 is not in operation (for example, when the autonomous vehicle 100 is parked at a sales base), the position information and vehicle information that are transmitted last are regarded as the latest information.

First, the customer transmits an operation request to the server apparatus 200 via the customer terminal 400 (step S11). When the customer performs a designated operation on the customer terminal 400, a control unit (not shown) of the customer terminal 400 generates an operation screen, and generates an operation request according to the operation. For example, the control unit outputs an icon or the like on the touch panel display (not shown), and generates an operation request based on the operation made by the customer. Moreover, the operation request may include the position information of the customer terminal 400. The position information may be input by the customer, or, when the position information can be acquired by using the OPS receiver or the like (not shown), the position information acquired therefrom may be used. Further, the operation request may include an identifier unique to the customer or the customer terminal 400.

Next, the server apparatus 200 (the operation command generation unit 2022) generates an operation command to cause the autonomous vehicle 100 to move to the customer's location and sell the medicine, according to the corresponding request (step S12). In step S13, the operation command generation unit 2022 selects the autonomous vehicle 100 to provide a service. For example, the operation command generation unit 2022 refers to the stored position information and vehicle information on each autonomous vehicle 100, and determines which autonomous vehicle 100 is available for providing the requested service. For example, the operation command generation unit 2022 selects the autonomous vehicle 100 which is closest to the customer's location based on the position information of each autonomous vehicle 100 collected by the vehicle information management unit 2021. The operation command generated by the operation command generation unit 2022 is transmitted to the selected autonomous vehicle 100 via the communication unit 201 (step S14). The operation command includes the location information of the destination and a signal indicating selling a medicine to the customer at the destination.

In step S15, the operation plan is generated based on the operation command that the autonomous vehicle 100 (the operation plan generation unit 1031) receives. For example, the autonomous vehicle 100 specifies a travelling route and a destination, and generates an operation plan for performing the task of selling the medicine at the corresponding destination (details will be described below) and for returning to a designated place (for example, the delivery base) after completing the task.

The generated operation plan is transmitted to the travelling control unit 1033, and the operation is started (step S16). Furthermore, during the operation, the position information and the vehicle information are periodically transmitted to the server apparatus 200.

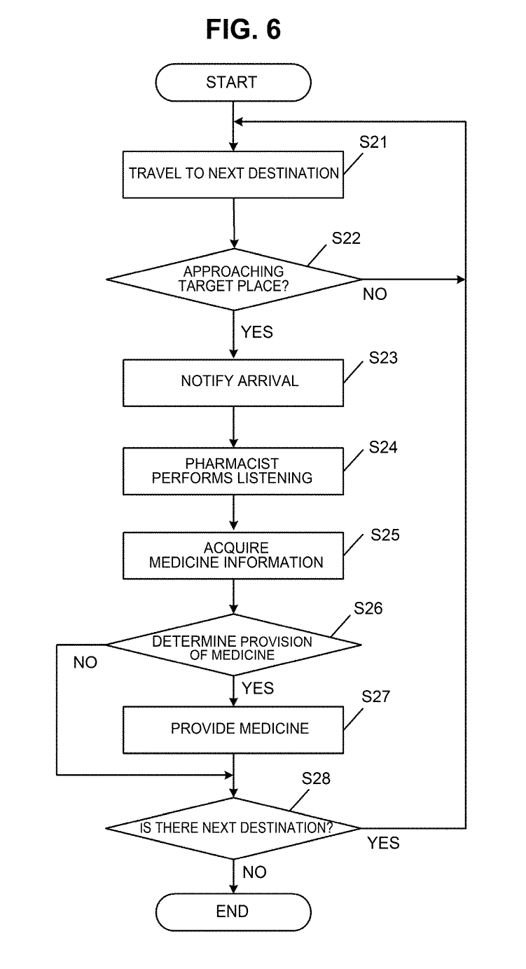

FIG. 6 is a flowchart of processes performed by the autonomous vehicle 100 after the operation is started in step S16. First, in step S21, the travelling control unit 1033 initiates travelling of the autonomous vehicle 100 toward the next destination based on the generated operation plan. Here, the destination refers to the place the customer designates when transmitting the operation request. Furthermore, when receiving operation requests from a plurality of customers, the server apparatus 200 may set destinations sequentially.

When the autonomous vehicle 100 approaches a target place (step S22), the travelling control unit 1033 searches for a place where the autonomous vehicle 100 can come to a stop in the vicinity, and stops the autonomous vehicle 100. The sales control unit 1034 notifies the customer terminal 400 of the arrival of the autonomous vehicle 100 (step S23). The notification may be made, for example, by sending a message to the customer terminal 400. As such, the message is displayed on the customer terminal 400 notifying that the autonomous vehicle 100 at which the medicine is sold has arrived at the designated place.

When the customer arrives at the autonomous vehicle 100 and operates the input and output unit 107 (for example, touches the screen of the input and output unit 107), the sales control unit 1034 causes the pharmacist to start an interview to the customer (step S24). In addition, a motion sensor (not shown) may be installed at the autonomous vehicle 100, such that the interview may be started when a person nearby is sensed by the motion sensor. As such, communication between the pharmacist and the customer becomes possible. In the present embodiment, each of the input and output unit 107 and the pharmacist terminal 300 includes a camera, with which video call is performed between the customer and the pharmacist in step S24. In addition, the interview may be performed via video and audio, or via audio only.

Further, the interview may be performed by causing the questions to be enquired to the customer to be displayed on the input and output unit 107, and the customer's answers to be transmitted to the pharmacist terminal 300, such that the pharmacist can proceed with the interview to customer while reading the customer's corresponding answers.

In the present embodiment, the medicines provided are Over-The-Counter (OTC) medicines which do not require prescriptions, and are classified into three types from Type-1 OTC medicines to Type-3 OTC medicines. Here, Type-1 OTC medicines refer to medicines that require special attention, among the medicines that, due to side effects, can cause health damage to an extent that it can cause adverse effects in a daily life. In countries such as Japan, pharmacists have an obligation to actively provide information to consumers when providing Type-1 OTC medicines.

In the present embodiment, the pharmacist determines which medicine to provide based on the results of the interview. Specifically, the pharmacist inputs information (including information on the type of the medicine) to identify the medicine into the pharmacist terminal 300, and the sales control unit 1034 acquires the information (step S25). The information on the medicine to be acquired here is referred to as medicine information. The medicine information may include information on the customer (for example, the pharmacist's opinion, the identifier, address, name of the customer, or the like) for whom the medicine is to be prescribed.

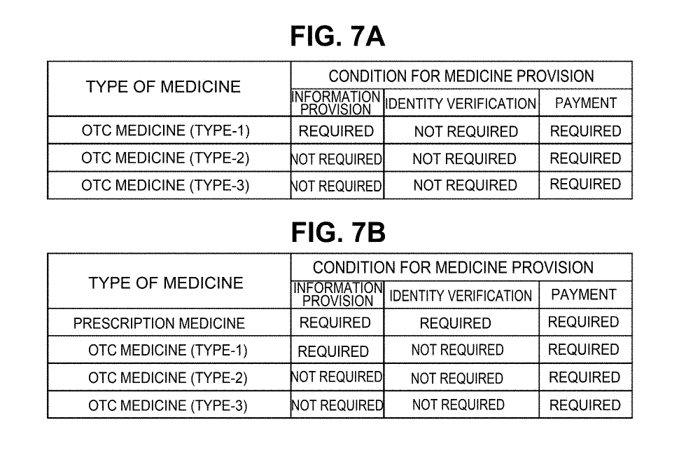

In step S26, the sales control unit 1034 determines whether the corresponding medicine can be provided to the customer based on the medicine information. FIG. 7A is a table illustrating the conditions for the determination made in step S26. For example, when the medicine to be provided belongs to Type-1 OTC, it is a condition to provide the medicine that both “provision of information by the pharmacist” and “payment for the medicine” are completed. The sales control unit 1034 enquires to the pharmacist terminal 300 whether the provision of information is completed, and acquires the answer. In addition, the payment for the medicine is made via a payment unit (not shown) or the like. Consequently, when all the conditions are met, an affirmative determination is made in step S26. Further, the payment for the medicine may be made in cash or by electronic payment. Moreover, the payment unit may be installed in the autonomous vehicle 100. Type-2 and Type-3 OTC medicines can be provided when payment is completed.

When it is determined that the medicine may be provided, the sales control unit 1034 unlocks the corresponding compartment of the storage apparatus 106 and provides the medicine (step S27).

Next, the travelling control unit 1033 determines whether there is a next destination based on the operation plan (step S28). When there is a next destination, the travelling control unit 1033 controls the autonomous vehicle 100 such that autonomous vehicle 100 continues the operation, and when there is no next destination, the travelling control unit 1033 controls the autonomous vehicle 100 such that the autonomous vehicle 100 returns to the delivery base.

As described above, according to the first embodiment, a system automatically delivering medicines by the autonomous vehicle 100 can be established. In particular, since the pharmacist terminal 300 and the autonomous vehicle 100 communicate with each other to enable communication between the customer and the pharmacist, it is possible to promptly deliver medicines for which a qualified person is obliged to make a determination or provide information for sale.

### Second Embodiment

In the delivery system according to the first embodiment, commercially available OTC medicines were target products for sale. On the other hand, in the second embodiment, other than the OTC medicines, the types of medicines which can be only purchased by designated people are added to the target products for sale. The medicines that can be only purchased by designated people refer to, for example, medicines that require prescriptions by a doctor or the like (hereinafter, prescription medicines).

In the delivery system according to the second embodiment, prescription medicines are provided only to customers eligible for receiving the medicine, for example, a customer who already has a prescription. Specifically, the sales control unit 1034 acquires eligibility information from the customer who will receive a prescription medicine, and determines whether the corresponding medicine can be provided based on the acquired eligibility information. The eligibility information is, for example, information to verify the identity of the customer, or information to verify the prescription prescribed to the customer. The information to verify the identity of the person may be any information which can identify the person. For example, the information to verify the identity of the person may be information relating to a driver's license or an Individual Number Card.

FIG. 7B is a table illustrating the conditions for determination made in step S26 according to the second embodiment. For example, when the medicines to be provided are prescription medicines, it is a condition to provide the medicines that in addition to provision of information by the pharmacist and payment for the medicine, the confirmation of the eligibility information is completed.

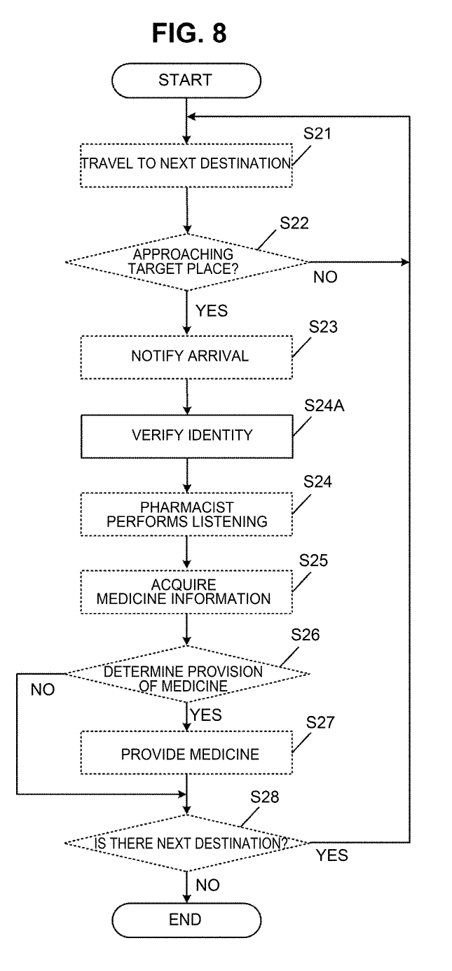

FIG. 8 is a flowchart of processes performed by the autonomous vehicle 100 according to the second embodiment. The same processes as in the first embodiment are represented by dotted lines, and a description thereof will be omitted. In the second embodiment, the pharmacist confirms the eligibility information held by the customer before performing the interview in step S24 (step S24A). In the second embodiment, for example, the input and output unit 107 includes a tool to read a verification document, such as an IC card reader or a camera, and the customer causes the tool to read the verification document such that the eligibility information is confirmed. For example, the input and output unit 107 can confirm the eligibility information by reading, with the camera, an ID card with a facial photo included thereon, the prescription, and the facial image. Confirmation of the eligibility information may be performed automatically or by the pharmacist. Further, when the information for identifying the customer and the information for identifying a medicine available for sale are already stored in a storage part (not shown), the eligibility information can be confirmed via the identity verification document only.

The eligibility information acquired in step S24A is used for the above-described determination in step S26. For example, when the conditions i) the medicine to be provided is a prescription medicine, ii) provision of information and confirmation of the eligibility information are completed, and iii) payment is completed are all satisfied, the sales control unit 1034 determines that the corresponding medicine can be provided.

As described above, according to the second embodiment, when providing medicines, it can be confirmed that the customer is eligible for receiving the medicines. In other words, it is possible to deliver medicines that are subject to stricter regulations, such as prescription medicines.

### Third Embodiment

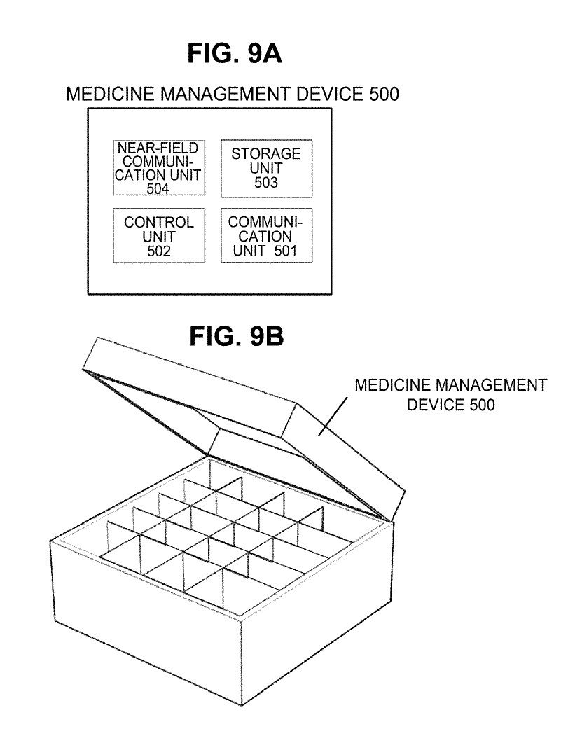

In the first and second embodiments, forms of medicine sales are exemplified. On the other hand, in the third embodiment, household medicines are replaced using the autonomous vehicle 100. In the third embodiment, a plurality of medicines provided from the autonomous vehicle 100 are stored in a medicine management device 500 and kept by the customer. FIG. 9A is a block diagram schematically illustrating an example of the 16 configuration of the medicine management device 500, and FIG. 9B is a diagram illustrating the exterior of the medicine management device 500.

The medicine management device 500 stores medicines and manages the use status and the expiration date of the medicines. In the third embodiment, Radio Frequency Identification (RFID) tag, in which an identifier and an expiration date of a medicine are stored, is attached to each medicine, and the medicine management device 500 is capable of reading the RFID tag of the stored medicine. Further, the RFID tag is attached to such a position that it is removed when the medicine is opened. In other words, the medicine management device 500 can acquire the use status (whether the medicine has been opened) and the expiration date of the stored medicine.

The medicine management device 500 includes a communication unit 501, a control unit 502, a storage unit 503, and a near-field communication unit 504. The communication unit 501, similar to the communication unit 105, is a communication interface to communicate with the server apparatus 200 via the network. The communication unit 501 may perform network communication via the customer terminal 400.

The control unit 502 controls the medicine management device 500. The control unit 502 is, for example, a CPU. The control unit 502 acquires the use status and the expiration date of the stored medicine via the near-field communication unit 504 (to be described below). When the predetermined condition is met, the control unit 502 transmits a signal to the server apparatus 200 indicating that the medicine needs to be replaced or replenished. The control unit 502 may perform the above processes by executing a program stored in the storage medium, such as a ROM, using a CPU (neither shown). The storage unit 503 stores information on the stored medicine, and includes a storage medium, such as a RAM, a magnetic disk, or a flash memory. The near-field communication unit 504 reads information from the RFID tag attached to the medicine.

In the third embodiment, when a new medicine is stored in the medicine management device 500, the control unit 502 detects the new medicine, acquires the identifier and the expiration date of the medicine via RFID, and stores the identifier and the expiration date in the storage unit 503. In addition, the control unit 502 determines whether replacement requirements (replenishment requirement) are met based on the acquired identifier and expiration date of the stored medicine. For example, when a medicine is approaching its expiration date, the control unit 502 transmits a signal to the server apparatus 200 indicating that the medicine needs to be replaced. Moreover, when there is an RFID tag that is not read (which means the medicine has already been consumed), or when the remaining number of the medicine identified via RFID is below a designated number, the control unit 502 transmits a signal to the server apparatus 200 indicating that the corresponding medicine needs to be replenished.

In the third embodiment, in response to the signal, the server apparatus 200 generates an operation command to replace or replenish the medicine, and transmits the operation command to the autonomous vehicle 100. As such, when the medicine needs to be replaced or replenished, the autonomous vehicle 100 is automatically sent to the customer. In addition, prior to generating the operation command, the server apparatus 200 may transmit a notification to the customer terminal 400 to adjust the schedule on which the autonomous vehicle 100 is to be sent.

In the third embodiment, the processes performed by the autonomous vehicle 100 are the same as the processes shown in FIG. 6, but differ in that, in step S27, old medicines are returned. In other words, when there is a medicine that is approaching its expiration date, a condition for providing a new medicine is to return the old medicine to the storage apparatus 106 before receiving the new medicine. Whether the medicine has been returned may be detected by a sensor installed on the storage apparatus 106 or may be determined by the pharmacist based on an image in the storage apparatus 106. Further, it is also possible to share a medicine return slot, identify the medicines that are put in, and provide new medicines corresponding to the medicines that are put in.

As described above, according to the third embodiment, it is possible to replace household medicines with new medicines by using the autonomous vehicle 100, such that a sufficient quantity of medicines can be provided and kept by the customer.

Although the present embodiment used RFID to detect the use status and the expiration date of a medicine, other techniques may be used. In addition, in the present embodiment, the RFID tag is removed when the medicine is consumed, but the present disclosure is not limited thereto. For example, a weight sensor or the like may be used to detect that the medicine has been consumed. In addition, in the present embodiment, the medicine management device 500 manages the state of the medicines, but a dedicated device is not necessarily required. For example, the server apparatus 200 may manage the information on the medicine provided to the customer. In the above case, since the server apparatus 200 cannot detect whether the customer has consumed the medicine, the server apparatus 200 may receive a notification from the customer terminal 400 whenever a medicine is consumed. Moreover, although the present embodiment exemplifies a system that delivers household medicines, the object to be provided is not limited to medicines. The present system can also be applied to whatever products that need to be kept and returned when the expiration date has passed.

### MODIFICATIONS

The above-described embodiments are merely examples, and appropriate modifications may be implemented within the technical scope of the disclosure.

For example, although the above embodiments describe that provision of a medicine is determined based on the conditions shown in FIGS. 7A and 7B, conditions other than the illustrated ones may also be used. Further, medicines may be classified according to the types different from the exemplified ones. The above embodiments may be modified and implemented as long as provision of a medicine can be determined based on criteria corresponding to the type of the medicine.

What is claimed is:

1. An autonomous mobile object configured to travel with a medicine loaded on the autonomous mobile object, the autonomous mobile object comprising:
a movement controller configured to control the autonomous mobile object such that the autonomous mobile object autonomously travels to a designated place according to a request of a customer;
an information provision unit configured to provide information on the medicine to the customer; and
a product provision unit configured to provide the medicine to the customer when a predetermined condition is met.

2. The autonomous mobile object according to claim 1, wherein the predetermined condition varies depending on an attribute of the medicine.

3. The autonomous mobile object according to claim 2, wherein the attribute of the medicine are based on a level of sales regulations to which the medicine is subject.

4. The autonomous mobile object according to claim 1, wherein the predetermined condition includes at least one of a condition that the information has been provided, and a condition that an identity of the customer has been verified.

5. The autonomous mobile object according to claim 1, wherein the information provision unit is configured to provide the information on the medicine via a voice call between a provider of the information and the customer.

6. The autonomous mobile object according to claim 5, wherein the provider of the information is a person qualified for selling or dispensing the medicine.

7. The autonomous mobile object according to claim 6, wherein the product provision unit is configured to provide, to the customer, a medicine selected by the qualified person from a plurality of medicines loaded in the autonomous mobile object.

8. The autonomous mobile object according to claim 1, wherein the product provision unit includes a return unit into which a medicine kept by the customer is returned, and the predetermined condition includes a condition that the medicine kept by the customer has been returned into the return unit.

9. A medicine delivery system comprising:
an autonomous mobile object configured to be loaded with a medicine and autonomously travel based on an operation command; and
a server apparatus configured to generate the operation command,
wherein the autonomous mobile object includes a movement controller configured to control the autonomous mobile object such that the autonomous mobile object autonomously travels to a designated place based on the operation command, an information provision unit configured to provide information on the medicine to a customer, and a product provision unit configured to provide the medicine to the customer when a predetermined condition is met, and
wherein the server apparatus is configured to generate the operation command based on a request of the customer, and transmit the generated operation command to the autonomous mobile object.

10. The medicine delivery system according to claim 9, wherein the predetermined condition varies depending on an attribute of the medicine.

11. The medicine delivery system according to claim 10, wherein the attribute of the medicine are based on a level of sales regulations to which the medicine is subject.

12. The medicine delivery system according to claim 9, wherein the predetermined condition includes at least one of a condition that the information has been provided, and a condition that an identity of the customer has been verified.

13. The medicine delivery system according to claim 9, wherein the information provision unit is configured to provide the information on the medicine via a voice call between a provider of the information and the customer.

14. The medicine delivery system according to claim 13, wherein the provider of the information is a person qualified for selling or dispensing the medicine.

15. The medicine delivery system according to claim 14, wherein the product provision unit is configured to provide a medicine, to the customer, selected by the qualified person from a plurality of medicines loaded in the autonomous mobile object.

16. The medicine delivery system according to claim 9, wherein the server apparatus includes a collection unit configured to collect an inventory status of a medicine kept by the customer, and the predetermined condition includes a condition that the medicine kept by the customer needs to be replaced or replenished according to the inventory status.

17. A medicine delivery method using an autonomous mobile object loaded with a medicine, the method comprising:
autonomously travelling to a designated place according to a request of a customer;
providing information on the medicine to the customer, and
providing the medicine to the customer when a predetermined condition is met.

18. A mobile object comprising:
a loading unit configured to be loaded with a medicine;
an information provision unit configured to provide information on the medicine to a customer; and
a product provision unit configured to provide the medicine to the customer when a predetermined condition is met.
